(19) United States
(12) Patent Application Publication
(10) Pub. No.: US 2019/0178990 A1
(43) Pub. Date: Jun. 13, 2019

(54) OPTICAL SET-UP FOR A LIDAR SYSTEM, LIDAR SYSTEM AND OPERATING DEVICE

(71) Applicant: Robert Bosch GmbH, Stuttgart (DE)

(72) Inventors: Siegwart Bogatscher, Leonberg (DE); Annette Frederiksen, Renningen (DE); Hans-Jochen Schwarz, Stuttgart (DE); Jan Sparbert, Rutesheim (DE); Klaus Stoppel, Mundelsheim (DE); Reiner Schnitzer, Reutlingen (DE); Stefanie Hartmann, Rottenburg Am Neckar (DE); Thomas Fersch, Reutlingen (DE); Thorsten Balslink, Kirchentellinsfurt (DE)

(21) Appl. No.: 16/321,223

(22) PCT Filed: Jul. 25, 2017
(86) PCT No.: PCT/EP2017/068715

§ 371 Date: Jan. 28, 2019

(30) Foreign Application Priority Data
Jul. 29, 2016 (DE) 10 2016 213 980.0

(51) Int. Cl. G01S 7/481; G01S 17/93

(52) U.S. Cl. CPC G01S 7/4817; G01S 17/936

(57) ABSTRACT

An optical set-up for a LiDAR system for the optical detection of a field of view, in particular for an operating device, a vehicle or the like, in which an optical receiver system and an optical transmitter system are designed at least on the field of view side having essentially coaxial optical axes and have a common optical deflection system, and on the detector side an optical detector system is designed and has an arrangement for directing incident light—in particular from the field of view—directly via the optical deflection system onto a detector device.

### BACKGROUND INFORMATION

The present invention relates to an optical set-up for a LiDAR system, a LiDAR system as well as an operating device. The present invention relates in particular to an optical set-up for a LiDAR system for the optical detection of a field of view, in particular for an operating device, a vehicle or the like. The present invention furthermore relates to a LiDAR system for the optical detection of a field of view as such and in particular for an operating device, a vehicle or the like. The present invention furthermore provides a vehicle.

When using operating devices, vehicles and other machines and equipment, operating assistance systems or sensor systems for detecting the operational surroundings are increasingly utilized. Apart from radar-based systems or systems on the basis of ultrasound, light-based detection systems are also increasingly used, e.g., so-called LiDAR (light detection and ranging) systems.

Conventional LiDAR systems have a disadvantage in that in a coaxial arrangement, conventionally beam splitters are often used to separate the beam paths of the optical transmitter system and the optical receiver system. Due to their functional principle, these result in attenuations in radiation intensity both in the transmitting path, that is, when emitting primary light, as well as in the receiving path, that is, when receiving secondary light from the field of view, and thus reduce the sensitivity and accuracy of the detection process.

### SUMMARY

The optical set-up according to the present invention may have the advantage that it is possible to do without the use of a beam splitter that attenuates the intensity of the radiation so that there are no resulting losses in intensity in the detection process. This increases the sensitivity and accuracy of the detection process and, according to the present invention, it may be achieved in that an optical set-up for a LiDAR system is provided for the optical detection of a field of view, in particular for an operating device, a vehicle or the like, in which on the one hand an optical receiver system and an optical transmitter system are developed at least on the field of view side (i) having essentially coaxial optical axes and (ii) a common optical deflection system and in which, on the other hand, an optical detector system is developed on the detector side which has means for directing light coming in—in particular from the field of view—directly via the optical deflection system onto a detector device. According to the present invention, the necessity of a beam splitter is eliminated because the optical detector system provided on the detector side has the ability and the corresponding means for directing, in direct cooperation with the optical deflection system, incident light, in particular from the field of view, via the optical deflection system onto the underlying detector device.

Preferred developments of the present invention are described herein.

In one advantageous development of the present invention, additional optical components, which may entail a corresponding loss, are eliminated in that the optical deflection system is designed and has means for directing light from the field of view directly onto the optical detector system.

An optical set-up that is particularly simple to control is achieved if, according to another development of the optical set-up of the present invention, the optical deflection system is designed to have a mirror, in particular a micromirror, that is able to be swiveled and/or oscillated in a one-dimensionally or two-dimensionally controllable manner. In this instance, a swiveling mirror is also to be understood as a mirror that is excitable to oscillations or to swiveling oscillatory motions.

Another advantageous development of the optical set-up of the present invention provides for the mirror or micromirror to be controllably swiveling and/or oscillating (i) in a first angular range for radiating primary light into the field of view and (ii) in a second angular range for directing secondary light from the field of view directly onto the optical detector system.

According to a preferred development of the present invention, a particularly compact construction of the optical set-up is achieved if the optical detector system is developed in direct spatial proximity of a detector element of the detector device.

Another development of the optical set-up in accordance with the present invention provides for the optical detector system to have a lens or form a lens, in particular in a hemispherical shape or in the shape of a combination of a perpendicular circular cylinder and a hemisphere on one face of the circular cylinder, the detector device or a sensor element of the detector device being situated on a side facing away from a convex side of the hemisphere.

Particularly low losses result in the optical set-up of the present invention if according to another advantageous specific development the optical detector system has or forms a material area embedding the optical detector device or a detector element of the detector device. In this case, boundary surfaces producing losses are avoided particularly effectively.

A particularly high degree of detection accuracy may be achieved if, according to another specific embodiment of the optical set-up of the present invention, the detector device or a sensor element of the detector device is situated essentially in the focal point or essentially in a focal plane of the optical detector system.

For a quick and accurate response of a LiDAR system in accordance with an example embodiment of the present invention, it is necessary that conditions are such that only small deflection ranges are required for the underlying optical deflection system.

Thus, one preferred specific embodiment of the optical set-up of the present invention provides for the detector device or a sensor element of the detector device and an element providing a primary light, in particular a light source, to be situated in direct spatial proximity of one another and/or lie in a plane essentially perpendicular to detector-side optical axes of the optical transmitter system and/or the optical receiver system.

For a precise illumination of the field of view and a detection of light from the field of view, according to an advantageous development of the optical set-up of the present invention, an optical aperture system may be developed, which is situated in front of the optical deflection system on the field of view side and which is designed and has means to direct primary light from the optical deflection system into the field of view and to direct light from the field of view onto the optical deflection system.

The present invention further relates to a LiDAR system for the optical detection of a field of view, in particular for a or as part of an operating device, a vehicle and the like, an optical set-up of the present invention being developed and used in accordance with the present invention.

According to another aspect of the present invention, an operating device is also provided, in particular a vehicle or the like, which is designed to include a LiDAR system of the present invention for the optical detection of a field of view.

### BRIEF DESCRIPTION OF THE DRAWINGS

Specific embodiments of the present invention are described in detail with reference to the figures.

FIG. 1 is a block diagram, which shows schematically a specific embodiment of the optical set-up of the present invention in connection with a specific embodiment of a LiDAR system of the present invention.

FIG. 2 shows in a schematic block diagram another specific embodiment of a LiDAR system of the present invention using an alternative development of the optical set-up of the invention.

FIGS. 4 through 5 show another specific embodiment of the optical set-up of the present invention in a LiDAR system and its representational characteristics.

FIGS. 6 through 8 show in a schematic and sectional lateral view specific embodiments of the optical set-up of the present invention with different possibilities of producing and providing primary light.

FIGS. 9 through 12 show in a schematic and sectional lateral view various optical detector systems as well as their representational behavior, which may be used in specific embodiments of the optical set-up of the present invention.

FIGS. 13 through 16 show graphs that illustrate various representational characteristics of specific embodiments of the optical set-up of the present invention.

### DETAILED DESCRIPTION OF EXAMPLE EMBODIMENTS

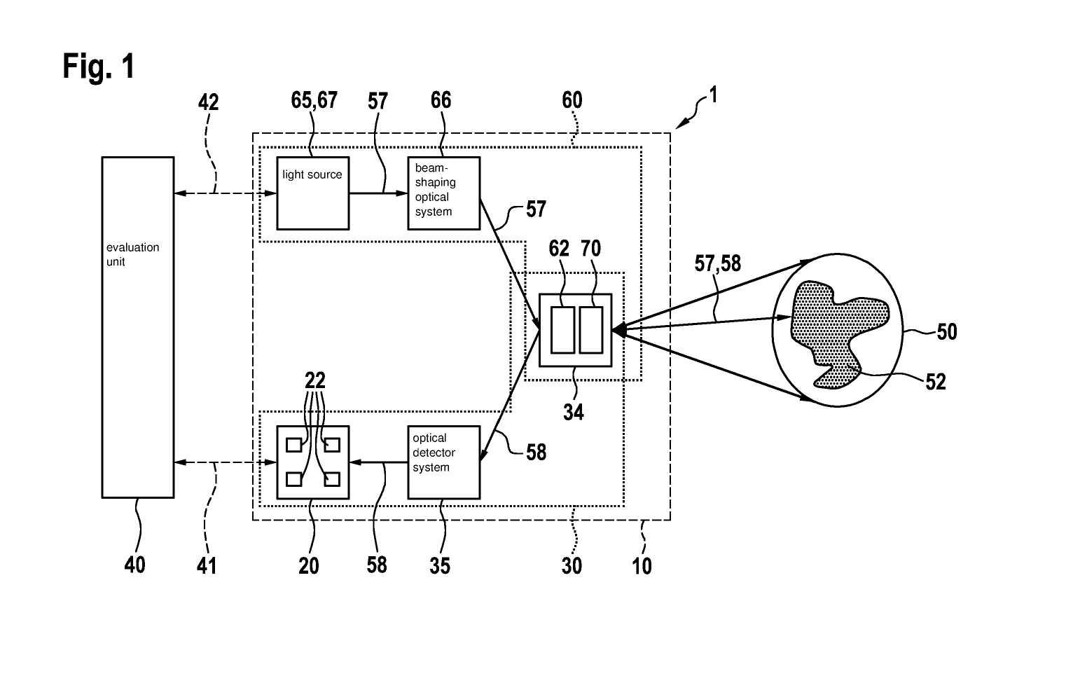

Exemplary embodiments of the present invention are described in detail below with reference to FIGS. 1 through 16. Identical and equivalent elements and components as well as elements and components that act in an identical or equivalent manner are designated with the same reference symbols. The designated elements and components are not described in detail in every case of their occurrence.

The represented features and further characteristics may be isolated from one another in any desired form and may be combined with one another as desired, without departing from the essence of the invention.

In the form of a schematic block diagram, FIG. 1 shows a specific embodiment of LiDAR system 1 of the present invention using a specific embodiment of the optical set-up 10 of the present invention.

LiDAR system 1 according to FIG. 1 has an optical transmitter system 60, which is fed by a light source 65, e.g. in the form of a laser, and emits primary light 57—possibly after passing through a beam-shaping optical system 66—into a field of view 50 for detecting and/or investigating an object 52 located there.

According to FIG. 1, LiDAR system 1 furthermore has an optical receiver system 30, which receives light, and in particular light reflected by object 52 in field of view 50, as secondary light 58 via an objective lens 34 as primary optical system and transmits it via an optical detector system 35 as secondary optical system to a detector device 20.

Light source 65 and detector device 20 are controlled via control lines 42 and 41 by a control and evaluation unit 40.

In FIG. 1, the common field of view-side optical deflection system 32 and the detector-side optical detector system 35 are represented schematically.

As part of primary optical system 34, optical deflection system 62, which may also be called an objective lens and which functions in connection with optical transmitter system 60 as an emitting objective projection lens, is designed to receive primary light 57 and to direct it into field of view 50 including object 52.

In connection with optical receiver system 30, the common field of view-side optical deflection system 62 works together with optical detector system 35 as secondary optical system in such a way that the secondary light 58 received from field of view 50 is directed onto optical detector system 35 in a direct manner, that is, without interposition of a beam splitter, in order thus to reach detector device 20 without interposition of additional optical components. Primary optical system 34 acts in connection with optical receiver system 30 as a receiving objective projection lens.

The provision of an optical aperture system 70 on the field of view side is optional and advantageous for a suitable emission of the primary light 57 and for the bundling reception of the secondary light 58.

Detector device 20 may be developed having one or more sensor elements 22.

Optical set-up 10 is designed for a LiDAR system 1 for the optical detection of a field of view 50, in particular for an operating device, a vehicle or the like, and is developed having an optical transmitter system 60 for emitting a transmit light signal into field of view 50, a detector device 20 and an optical receiver system 30 for optically projecting field of view 50 onto detector device 20.

Optical receiver system 30 and optical transmitter system 60 are designed on the field of view side (i) so as to have essentially coaxial optical axes, and they have a common optical deflection system 62.

Optical receiver system 30 has a secondary optical system 35 on the detector side, which is designed and comprises means for directing light coming in from the field of view 50 via optical deflection system 62 onto detector device 20.

In optical set-up 10, optical transmitter system 60 is generally designed and has an arrangement for emitting primary light 57 into field of view 50.

Furthermore, in optical set-up 10, optical receiver system 30 is designed and has an arrangement for optically projecting field of view 50 onto detector device 20.

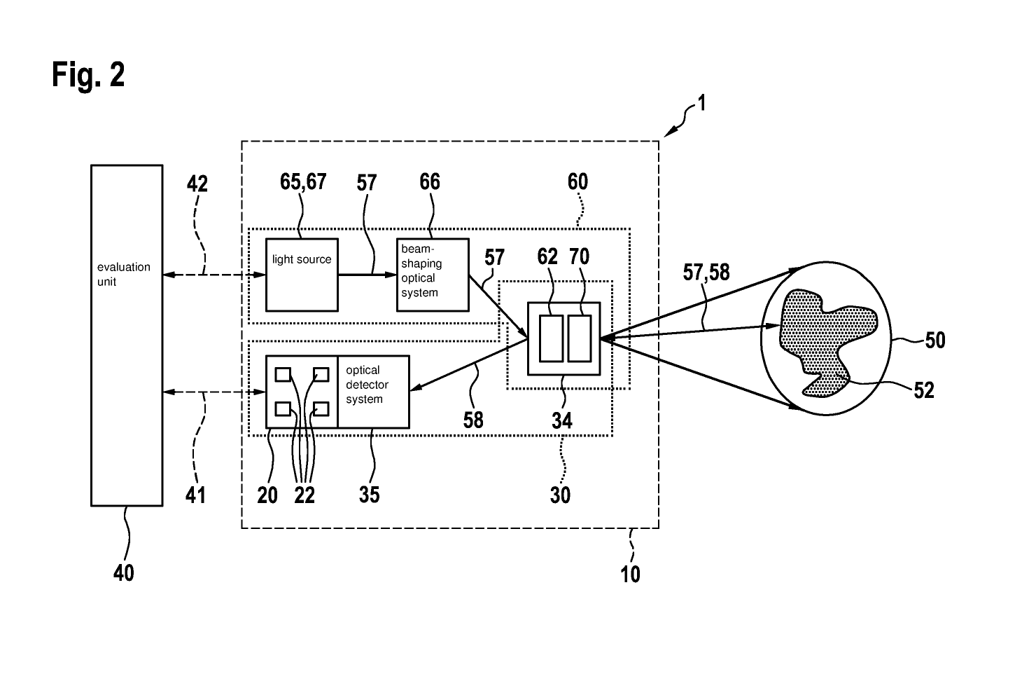

FIG. 2 shows in a similar way as FIG. 1 another specific embodiment of a LiDAR system 1 using an alternative development of the optical set-up 10 of the present invention.

The components provided in the specific embodiment shown in FIG. 2 correspond essentially to the components shown in FIG. 1. In FIG. 2, however, emphasis is placed on (a) the spatial proximity between optical detector system 35 as secondary optical system of optical receiver system 30 with respect to detector device 20 and sensor elements 22 on the one hand and, on the other hand, (b) the direct spatial proximity of the beam paths of optical transmitter system 60 and optical receiver system 30 and in particular the direct spatial proximity of detector device 20 having sensor elements 22 with respect to light source 65 as element 67 providing primary light 57.

FIG. 3 shows a more concrete specific embodiment of LiDAR system 1 of the present invention using a specific embodiment of the optical set-up 10 of the present invention.

This specific embodiment implements the basic principle shown in FIGS. 1 and 2 more concretely. Detector device 20 including a sensor element 22 together with a light source 65 or generally together with an element 67 providing a primary light 57 are situated in or on a common substrate 25, which defines detector plane 24.

For this purpose, sensor element 22 and element 67 providing the primary light 57 are situated in direct spatial proximity to one another. This has the consequence that optical deflection system 62, e.g., in the form of a micromirror 63 that is able to swivel or oscillate in a controllable manner, only has to be swiveled about directly adjacent angular ranges and/or about angular ranges of small dimension in order thereby to illuminate field of view 50 including the object 52 situated therein—possibly mediated by optical aperture system 70—with primary light 57 and/or to direct secondary light 58 from field of view 50 onto detector device 20 including sensor element 22.

For this purpose, optical detector system 35 has the form of a lens 36 including a hemispherical segment 37 and a cylindrical segment 38 having a common axis of symmetry 39. Hemispherical segment 37 is attached directly—e.g., as a single piece of material—on the face or surface of the cylindrical segment facing away from detector device 20.

The differently marked beams for secondary light 58 correspond to different distances 71 between optical aperture system 70 and object 52.

In specific embodiments without optical aperture system 70, the distance 71 between object 52 in field of view 50 and optical deflection system 62 is consequential.

In FIG. 3, the beam of secondary light 58 designated by reference numeral 72-1 comes from a near object 52 of field of view 50, whereas the beam of secondary light 58 designated by 72-3 comes from a more remote object 52 of field of view 50. For traversing a greater distance, secondary light 58 requires more time, within which mirror 63 of the optical deflection system swivels by a greater angle. Beam 72-3 is thus deflected to a greater degree than beam 72-1.

Optical deflection system 62 and particularly its mirror 63 have a first angular range 64-1, which is used to project secondary light 58 from field of view 50 onto detector device 20, and a second angular range 64-2, which is used to distribute primary light 57 from element 67 providing primary light 57 into field of view 50.

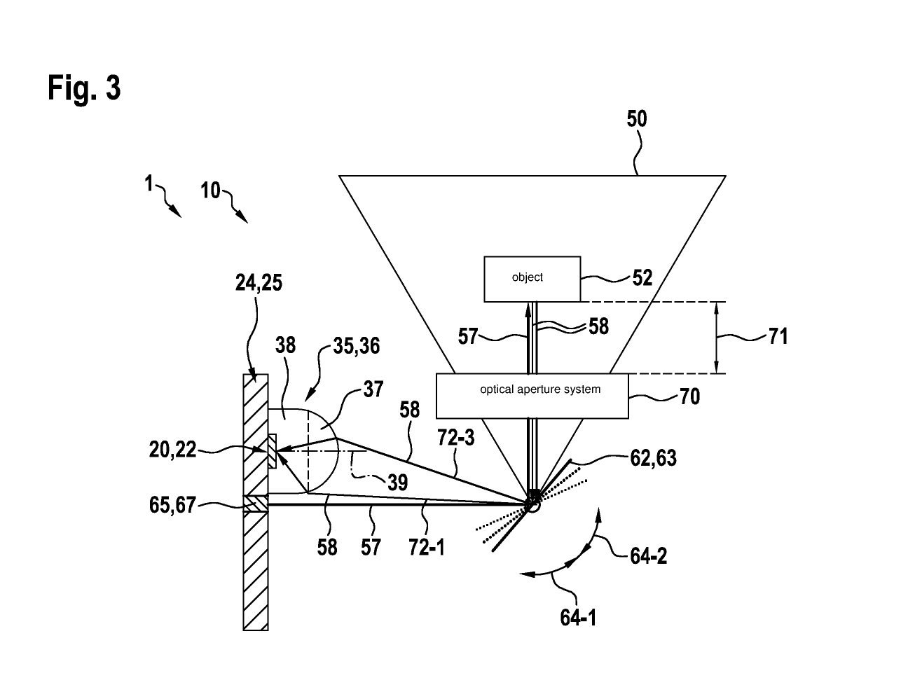

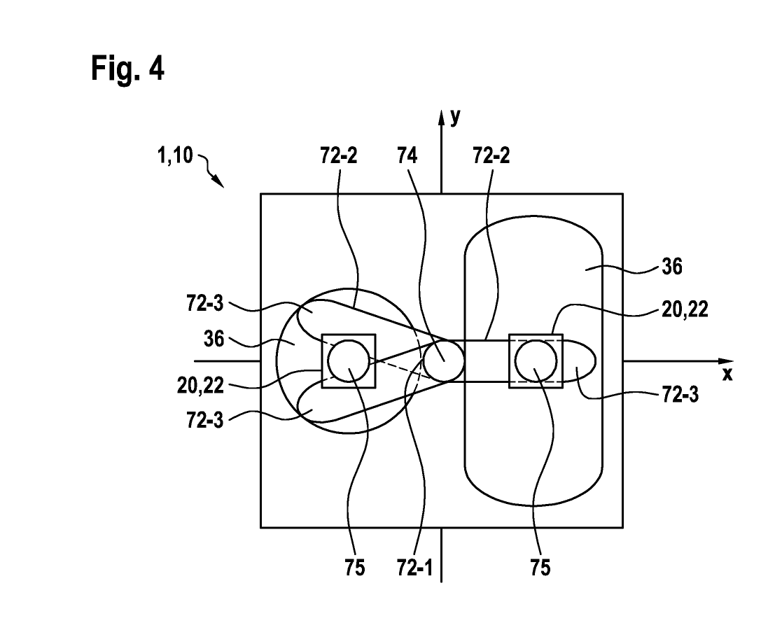

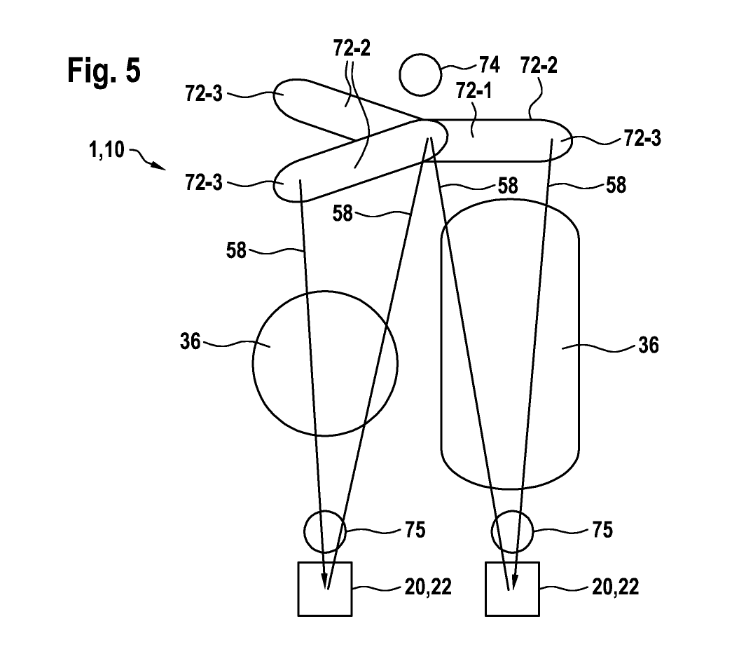

FIGS. 4 and 5 show schematically the projection relations in a specific embodiment of a LiDAR system 1 with a specific embodiment of the optical set-up 10 from FIG. 3 including the distance-dependency, for a one-dimensionally moved optical deflection system 62 respectively one the right side and for a two-dimensionally moved optical deflection system respectively on the left side. FIG. 4 provides a simple top view, while FIG. 5 provides an exploded view.

FIGS. 4 and 5 show the path of secondary light 58 in relation to lenses 36 and detector device 20 having thin sensor elements 22. The figures show the location 74 of the laser aperture and the beam position 75 after bundling or collimating.

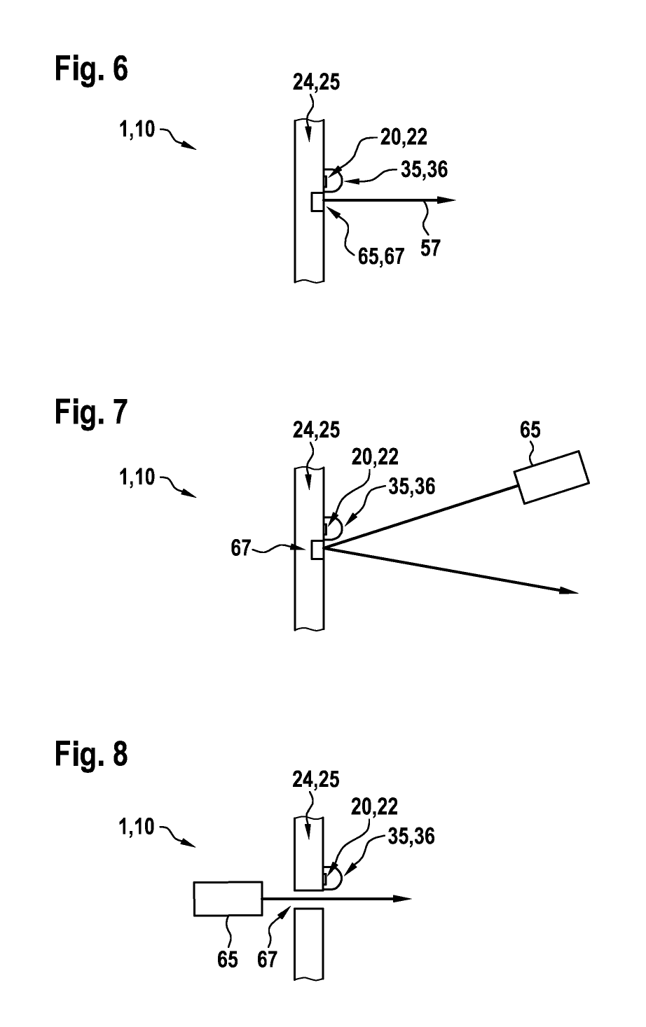

FIGS. 6 through 8 show different specific embodiments of the optical set-up 10 of the present invention with a focus on the different implementations of the generation of primary light 57.

In the specific embodiment shown in FIG. 6, the element 67 producing primary light 57 is formed by a light source 65 itself, for example a laser light source, a laser diode or the like.

In the specific embodiment shown in FIG. 7, an external light source 65 is used, which produces primary light 57 and directs it onto a mirror element as the element 67 in substrate 25 providing the primary light 57.

In the specific embodiment shown in FIG. 8, the element 67 providing primary light 57 is a through hole in substrate 25, the actual light source 65 being located on its backside or the side facing away from detector device 20.

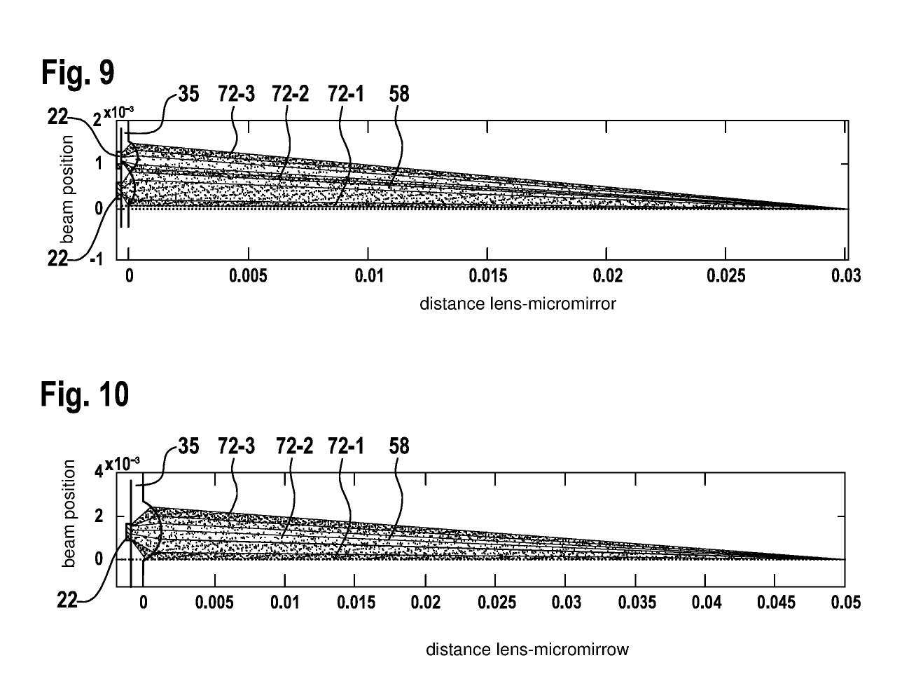

FIGS. 9 through 12 schematically show projection relations in different specific embodiments of the optical set-up 10 of the present invention. Graphs are shown in each instance, on the abscissa of which a specific distance measure is represented, while the ordinate, as a function thereof, shows the beam position of secondary light 58 on sensor elements 22 of a detector device 20 behind optical detector system 35.

Indications are also provided for a small distance 72-1, an intermediate distance 72-2 and a large distance 72-3 of object 52 in field of view 50.

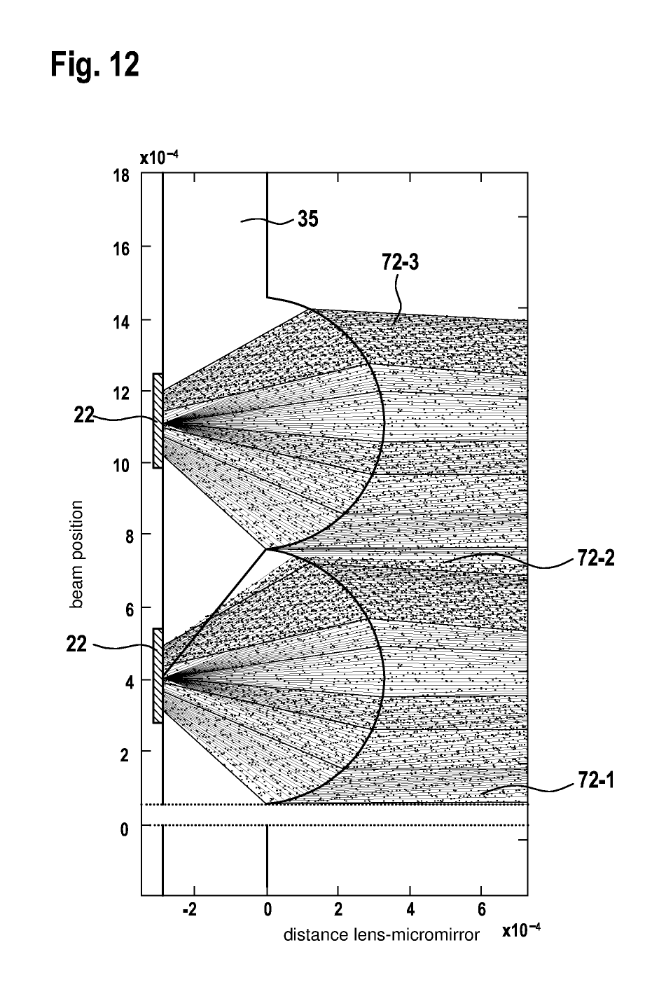

FIGS. 9 and 12 respectively show in schematic fashion an optical detector system 35 having two lenses 36 and the projection relations that obtain in each case.

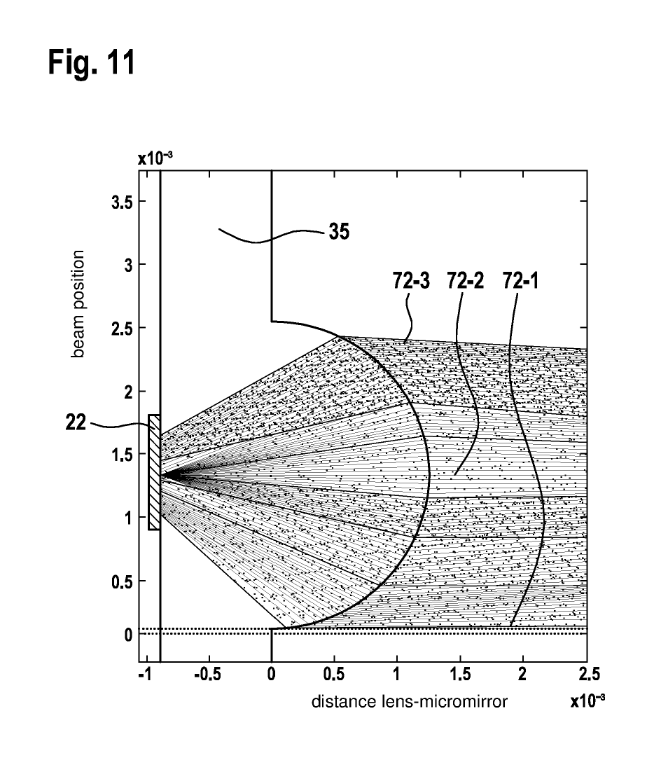

FIGS. 10 and 11 show a set-up having only one lens 36 for the construction of optical detector system 35.

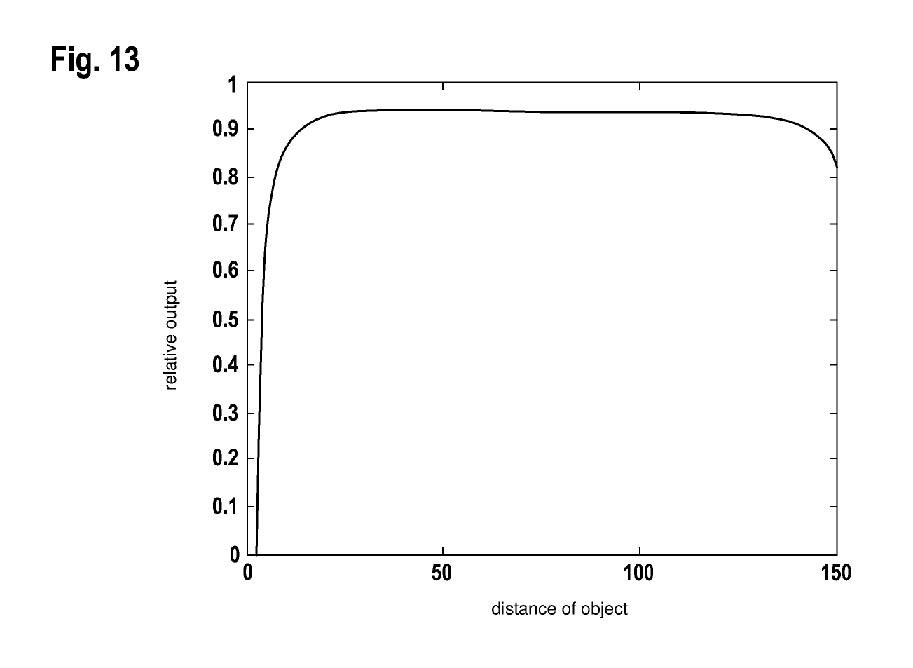

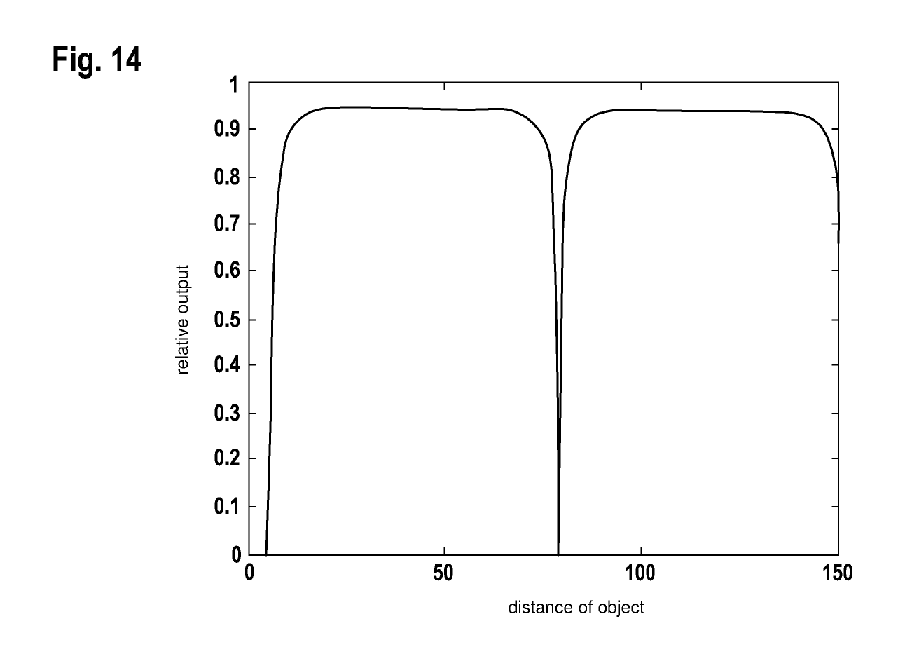

FIGS. 13 and 14 show in the form of graphs the relative light outputs in optical detector systems having one lens 36 and having two lenses 36, which occur on the respective sensor element 22, as a function of the distance of object 52.

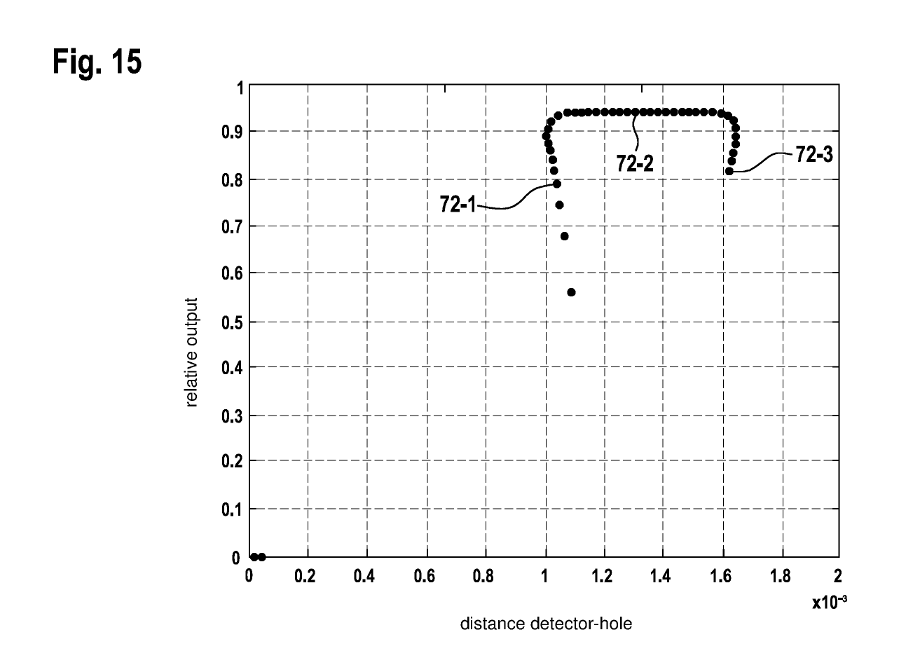

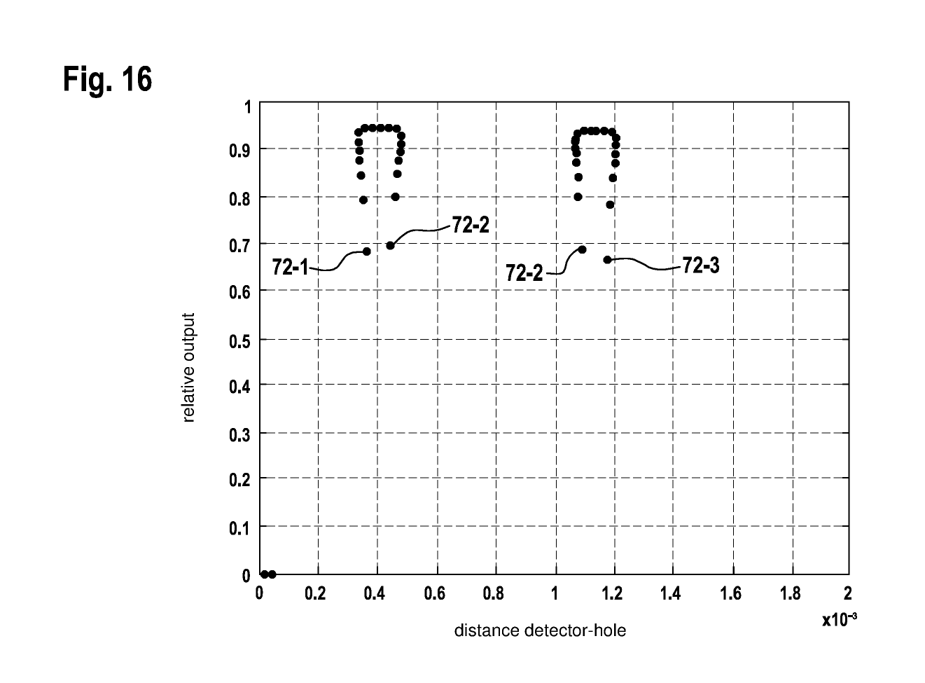

FIGS. 15 and 16 respectively show the relative output on sensor element 22 of detector device 20 as a function of the distance of the hole, which is plotted on the abscissa, using the code for small distances 72-1, intermediate distances 72-2 and great distances 72-3 from object 52 in field of view 50.

These and further features and characteristics of the present invention are explained in more detail below:

Conventional LiDAR architectures 1 often use coaxial arrangements of transmitter path 60 and receiver path 30. The transmitter itself is made up, e.g., of a modulated laser diode as light source 65. In the simplest case, e.g., brief pulses of a high to very high peak output are generated. Detector device 29 has a single or several AP diodes (avalanche photo diode) as sensor element 22. PIN diodes are also popular. Silicon and germanium diodes are less expensive than diodes made of compound semiconductors (e.g., InGaAs), but only allow for a less efficient detection of radiation of wavelengths of more than approx. 900 nm.

In the coaxial arrangement, conventionally a beam splitter is often required, which deflects the laser output for example at a ratio of 1:1 (50%) in different directions. I.e., the transmit beam passes through an optional optical system and the beam splitter before being deflected by a deflection unit 62 in the direction toward field of view (FOV) 50, in which the distance, the presence or the reflective characteristics of an object 52 assumed to exist there are to be measured.

The direction of object 52 as target may be determined by the position of deflection unit 62. Depending on the specific embodiment, a further optical system is provided. The beam reflected by object 52 follows as secondary light 58 the same path as primary light 57 in the transmit path 60. This is the case when deflection unit 62 moved only negligibly during the measurement. This condition is generally fulfilled.

The conventionally utilized beam splitter deflects a portion of the receive beam onto a receiver, a further optical system being possibly required.

Aspects of the conventional constellation are:
Only the interesting section of FOV 50 is projected onto the receiver. This preselection reduces the noise output on the receiver resulting from interference sources (brake lights, headlights, sunlight).
The deflection unit directs the receive beam always onto the same spot on the detector. As a result, it is possible to design the detector to be very small (single diode) or to use a better receiving diode (InGaAs).
The beam splitter deflects a portion of the transmit output into the housing instead of directing it onto the target. As a result, a higher transmit output must be provided for the transmitter. The deflected beam may interfere with the receiver.
The receive output is also reduced by the beam splitter. This is a critical point since the receive output is normally very low and a further reduction is very disadvantageous for the system behavior.

In a system having a separated constellation, by contrast, the target direction must be determined either by the deflection unit or by the receiver. If the appearance angle of the target is determined or specified by the position of the deflection unit, a single large photo diode suffices in principle, onto which the entire FOV is projected. This approach has the disadvantage that a lot of ambient light is directed onto the detector. Alternatively, the receiver may be constructed from a photodiode array or a photodiode linear array. The FOV is thereby divided into parts and a single photodiode is illuminated only by a part of the FOV and thus is illuminated only by a portion of the ambient light.

Aspects of this way of proceeding are:
The optical receive paths and transmit paths may be implemented independently of one another, according to their individual requirements, and no compromise is necessary.
A very large receiver diode array is required. For this reason, it cannot be produced cost-effectively from compound semiconductors. This prevents the use of large eye-safe wavelengths. Such an array also requires a great amount of electrical energy, which requires expensive cooling measures.

It is an objective of the present invention to make a beam splitter superfluous in a coaxial LiDAR system 1. The system offers the mentioned advantages of a conventional coaxial system without its disadvantages. Moreover, large and expensive detectors become superfluous.

A main feature of the present invention focuses the receive pulse output issuing from a micromirror 63 onto a small area or point in a plane 24.

The separation of transmit path 60 and receive path 30 is assumed by an optical deflection system 62 and in particular by a rapidly oscillating micromirror 63. The beam of secondary light 58 is focused further by an optical detector system 35, which is located directly in front of detector device 20.

In particular, the transmitter unit, e.g. in the sense of an element 67 providing the primary light 57, and the receiver unit, e.g., in the sense of detector device 20 having a sensor element 22, are situated in very close proximity to each other.

Advantages of the present invention are:
No beam splitter is required. As a result, no receive output is lost. The full transmit output is emitted.
A single small photodiode or a photodiode linear array or a photodiode array may be used in detector device 20.
The possibility of being able to make do with one single receiving diode (InGaAs) allows for the use of large eye-safe wavelengths, e.g. in the range of approximately 1,550 nm, in economical fashion.
A large receiver array may be omitted.
In a suitable design of optical detector system 35, an optical zero-meter signal may be provided.
A lens 36 of optical detector system 35 may be applied directly onto the detector in a very space saving manner.

The basic principle is shown in FIG. 3 for example.

Components of the present invention may be configured on a plane 24, called the detector plane. This plane may be flat or vaulted. Either a printed circuit board (PCB) or a semiconductor chip are possible.

A brief laser pulse is emitted from a small surface on the detector plane. The laser beam is directed via a deflection unit 62 onto a point or an object 52 in field of view or FOV 50.

Additional optical aperture systems 70 are possible.

The light output reflected or diffusely scattered by object 52 is collimated by optical aperture system 70 and is again directed onto optical deflection system 62 as deflection unit.

Deflection unit 62 is a mirror 63 oscillating in a plane for example.

During the pulse propagation time from mirror 63 to object 52 and back, the mirror position changed slightly since mirror 63 oscillates continuously and rapidly. As a result, the receive pulse is projected onto a location on detector plane 24 that differs from the emitter area. A small distance of object 52 results in a slight deflection of the receive beam, beam 72-1 in FIG. 3. A greater distance of object 52 results in a stronger deflection, beam 72-3 in FIG. 3.

The deflection depends on the oscillation frequency of mirror 63, on distance 71 between object 52 and mirror 63, on the distance between detector plane 24 and mirror 63 and possibly on the aperture.

Without further measures, the receive beam projected onto detector plane 24 would describe a line of possible projection locations, depending on object distance 71.

The receive beam of secondary light 58 must be directed onto a sensor element 22. If the above-mentioned parameters are selected for a great deflection, then the projected beam would become very long and require large detectors. In the opposite case, i.e. when selecting the parameters for small deflections, reflections on near objects 52 would have the result that the receive beam would again strike the emitter surface and could not be detected.

A remedy is provided by the introduction of an optical detector system 35, which is mounted in front of or directly on the detector module as detector device 20.

FIG. 3 shows a lens 36 having a hemispherical lens part 37 and a cylindrical substructure or pedestal 28.

FIG. 3 shows a sectional view of an axis symmetrical lens 36.

Other geometries and specific embodiments of optical detector system 35 are possible.

If lens 36 is implemented accordingly, all incident beams are directed onto a very small area regardless of the corresponding object distances 71. The selection of the FOV section together with the associated reduction of the ambient light intensity is thus effected by micromirror 63.

FIG. 4 shows the top view onto detector plane 24. FIG. 5 complements FIG. 4 with an exploded view. The individual elements from FIG. 5 stacked one on top of the other result in the representation in FIG. 4. The further elucidation refers to FIG. 5 from top to bottom.
(1) The right side respectively represents the case of a mirror 63 that oscillates in only one plane; a one-dimensional or 1D case. The left sides concern the case of a mirror 63 that moves also in an orthogonal direction and that deflects the beam from the plane at y=0; two-dimensional or 2D case. The 1D case is approximately also given when the vertical frequency is selected to be much smaller than the horizontal frequency.
(2) The laser aperture is at the center. Various specific embodiments of the same are explained later.
(3) The representation of the beam movement is the totality of all possible projection locations of the received laser beam. Depending on the distance of object 52, the receive beam is deflected to a greater or lesser extent. The legend on the right side itemizes the distance information by using reference numerals 72-1, 72-2, 72-3 for small, average and great distances, respectively.
   In the case of a one-dimensional deflection of mirror 63, no deflection occurs in the y direction. In the two-dimensional case, a deflection will also occur in the orthogonal direction (left).
   This representation shows the beam positions uninfluenced by the lens.
(4) Two specific embodiments of lenses 36 are shown. On the left is the dome-shaped lens 36 already explain in FIG. 3, on the right is a lens 36 of similar shape but more extended in the y direction. The left lens 36 is able to compensate also for the vertical deflection by 2D mirror 63. A wider lens 63 could make the collimation more independent of an erroneous adjustment.
(5) Receive beam position 75 following collimation is ideally point-shaped, regardless of object distance 71.
(6) The detector area is shaped and dimensioned in such a way that all receive beams are focused on it regardless of object distance 71.

Laser Aperture

In the specific embodiment shown in FIG. 6, the laser aperture is formed by a laser module that is integrated in detector plane 24 as light source 65.

The laser may be mounted as an external component on substrate 25 (PCB/semiconductor material, “die”, “chip”) and wired on substrate 25.

It is possible for the wiring to occur directly on substrate 25. The laser may be worked out directly from the semiconductor material. In this instance, however, a high degree of electromagnetic interference (EMV, EMI) may be caused by high-energy switching elements on detector plane 24.

According to FIG. 7, the aperture may be made of a mirrored surface on substrate 25, which is irradiated by a laser 65.

According to FIG. 8, substrate 25 may be provided with an opening or a hole at the location of the aperture, which the laser beam penetrates from the back side.

In this case and in the case of FIG. 7, the EMV problem is circumvented by a possible great distance between laser 65 and sensor element 22.

Simulation results are presented in the following.

Beam Path

FIGS. 9 through 12 show the simulated beam path for individual rays (ray tracing). All rays are emitted by a deflection unit 62 assumed to be point-shaped (right). The object distance 71 is represented as 72-1 close, 72-2 average, 72-3 distant.

The representations of FIGS. 11 and 12 show that all rays are focused onto a small area. The principle may be extended to a greater number of lenses 26, which decreases the size of the focal points.

FIGS. 9 through 12 thus show simulated beam paths for a single-lens configuration—FIGS. 9 and 12—and for a two-lens configuration—FIGS. 10 and 11.

FIGS. 9 and 10 show that the beams of secondary light 58 emanate from a point-shaped deflection unit 62 (right) and strike detector plane 24 (left).

FIGS. 11 and 12 show lens 26 in detail for a one-lens and respectively for a two-lens configuration.

Parameters
distance between mirror 63 and detector plane 24: 3 cm or 5 cm for one lens and two lenses 36 respectively
aperture diameter=100 μm,
   lens diameter=(1.25 mm and 0.35 mm respectively)
pedestal height=0.9 mm and 0.3 mm respectively)
mirror oscillation frequency=30 kHz
Lens material: polycarbonate at n=1.6

Discussion of Minimum Range

FIGS. 13 and 14 show the output striking the sensor surface as a function of the object distance 71. The represented values refer to the output emanating from mirror 63. The output missing at 100% is deflected by spherical lens 37 in the event of an angle of incidence that is too low. Receive beams for very close objects 52 are not sufficiently deflected by mirror 63 and again strike the laser aperture, while somewhat more distant objects 52 produce beams that strike lens 36 at a very low angle and are attenuated as a result.

Incident beams always have a certain extension. Very close targets 52 also produce a very strong backscatter signal. For these reasons, in a real case, it will be possible to detect even very close objects 52.

Furthermore, very strong receive signals may override the detector. In this case, an attenuation of the receive signal would even be advantageous.

Lens Shape

Dome-shaped and pill-shaped lenses 37 with pedestal 38 are shown.

The concrete specific embodiment of optical detector system 35 may be adapted to the particular application. The main point for this purpose is that the optical detector system 35 focuses if possible all incident beams of secondary light 58 on one or multiple areas that are as small as possible, as point-shaped as possible.

Possible specific embodiments of the optical detector system are inter alia:
A plano-convex lens 37 having a pedestal 38 is possible.
So far, maximally one lens 36 and one sensor element 22 per side were shown. The expansion of the number of lenses and detectors in the x direction in FIG. 4 (micro-lens array/detector linear array) is possible.
Figure respectively showed only one lens 36 above the aperture. An arrangement of lenses in one direction possibly suffices. In this case, it would only be possible to evaluate the oscillatory motion of deflection unit 62 in one direction.
A holographic element would accomplish the deflection without a curved surface.
An asymmetrically shaped element could improve the blind minimum range by offering in the area of the opening a smaller angle with respect to the incident beam.

Detector Output

In FIGS. 15 and 16, the output incident on detector plane 24 is plotted as a function of the distance from the opening, for the case of a single lens 36 (left) and for two lenses 36 (right). Again, output is seemingly lost for very close objects 52. The output for objects 52 further removed may be distributed on the detector surface nearly at will by adapting the lens geometry.

In the case of FIG. 15 for a single lens 36, the entire output is distributed on an area of approx. 600 μm diameter.

In the case of FIG. 16 for two lenses 236, two detectors of 200 μm diameter are required.

An expansion to more than two lenses 36 is possible.

Increase of the Pulse Succession Frequency

FIG. 13 indicates that beams from very distant objects 52 are attenuated and are no longer directed onto detector device 20. This may be a very useful effect. For conventional LiDAR systems must wait before initiating a new scan (=emission of a laser beam) until the receive pulses from very distant objects 52, which are actually located beyond the specified maximum distance, have also been received.

In a LiDAR system 1 of the present invention, beams from very distant objects 52 would be directed onto a point in detector plane 24 at which no sensor element 22 exists. Thus a higher pulse succession frequency would be possible, and the system dynamics could be increased.

1-12. (canceled)

13. An optical set-up for a LiDAR system for optical detection of a field of view for an operating device or a vehicle, comprising:
an optical receiver system and optical transmitter system configured at least on a field of view side so as to have coaxial optical axes and a common optical deflection system; and
on a detector side, an optical detector system including an arrangement for directing light coming in from the field of view via the optical deflection system onto a detector device.

14. The optical set-up as recited in claim 13, wherein the optical deflection system includes an arrangement for directing light from the field of view directly onto the optical detector system.

15. The optical set-up as recited in claim 13, wherein the optical deflection system includes a micromirror, that is able to be swiveled and/or oscillated one-dimensionally or two-dimensionally in a controllable manner.

16. The optical set-up as recited in claim 15, wherein micromirror is able to be swiveled and/or oscillated in a controllable fashion: (i) in a first angular range for irradiating primary light into the field of view, and (ii) in a second angular range for directing secondary light from the field of view directly onto the optical detector system.

17. The optical set-up as recited in claim 13, wherein the optical detector system is in direct spatial proximity of a detector element of the detector device.

18. The optical set-up as recited in claim 13, wherein the optical detector system has or forms a lens in the shape of a hemisphere or in the shape of a combination of a perpendicular circular cylinder and a hemisphere, on a front side of the circular cylinder, and wherein the detector device or a sensor element of the detector device is situated on a side facing away from a convex side of the hemisphere.

19. The optical set-up as recited in claim 13, wherein the optical detector system has or forms a material area embedding the detector device or a detector element of the detector device.

20. The optical set-up as recited in claim 13, wherein the detector device or a sensor element of the detector device, is situated in a focal point of the optical detector system or in a focal plane of the optical detector system.

21. The optical set-up as recited in claim 13, wherein the detector device or a sensor element of the detector device, and a light source, are situated in direct spatial proximity of one another and/or lie in a plane perpendicular to detector-side optical axes of the optical transmitter system and/or the optical receiver system.

22. The optical set-up as recited in claim 13, further comprising:
an optical aperture system disposed in front of the optical deflection system on the field of view side and includes an arrangement for directing primary light from the optical deflection system into the field of view and for directing light from the field of view onto the optical deflection system.

23. A LiDAR system for optical detection of a field of view for an operating device or a vehicle, the LiDAR system comprising:
an optical set-up, including:
an optical receiver system and optical transmitter system configured at least on a field of view side so as to have coaxial optical axes and a common optical deflection system; and
on a detector side, an optical detector system including an arrangement for directing light coming in from the field of view via the optical deflection system onto a detector device.

24. A vehicle or robot, including a LiDAR system for optical detection of a field of view, the LiDAR system comprising:
an optical set-up, including:
an optical receiver system and optical transmitter system configured at least on a field of view side so as to have coaxial optical axes and a common optical deflection system; and
on a detector side, an optical detector system including an arrangement for directing light coming in from the field of view via the optical deflection system onto a detector device.
